(19) United States
(12) Patent Application Publication
(10) Pub. No.: US 2006/0242057 A1
(43) Pub. Date: Oct. 26, 2006

(54) Method and loan for financing a property expense increase associated with rising property value

(76) Inventor: Carlo Velarde, Naples, FL (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/110,074

(22) Filed: Apr. 20, 2005

(51) Int. Cl. G06Q 40/00

(52) U.S. Cl. 705/38

(57) ABSTRACT

A method for financing increases in property expenses, such as increases in property taxes and insurance premiums, associated with an increase in property value. Under a secured increase loan, a lender agrees to pay the increase of the expenses, either one-time or annually, above the borrower's initial or existing expenses associated with the property, and the borrower agrees to repay the loan within a predetermined time period.

### BACKGROUND OF THE INVENTION

The present invention relates to a method for financing increases in property-related expenses attributed to rising property value, such as real property.

A typical mortgage loan for a home includes principal and interest payments to a lender. The property serves as collateral to secure the loan. In addition to principal and interest payments, homeowners often have additional expenses associated with the property, such as property taxes and insurance. The additional expenses are estimated at the time of origination of the loan (including new home purchase or refinance loans), and a lender will require that the homeowner make monthly escrow payments with the principal and interest payment to cover the taxes and insurance. With some loans, homeowners pay the taxes and insurance directly to the respective government taxing agency and the property insurer.

Although homeowners budget for property-related expenses based on the estimates at the time of loan origination, the additional expenses typically increase as the property value increases. Homeowners of properties that increase in value rapidly can be faced with a marked increase in property taxes (and property insurance premiums) over the original estimate of these additional expenses at the time the loan was originated. Accordingly, sharp annual increases in additional expenses often cause the lender to raise the monthly escrow payments. If the homeowner pays the additional expenses directly, a significant property tax bill reflecting such increase (and/or insurance premium increase to cover property value increase) will be due. For property owners on fixed budgets and/or with limited liquidity, such marked increases in property taxes or other additional expenses can present a financial hardship. Based on annual assessments where the property value continually increases, the yearly increase of additional expenses continues to rise, and the financial constraints become greater and greater upon the homeowner.

If the homeowner's income or liquidity is insufficient to cover the rising additional expenses, the property owner might have to liquidate other property to pay the expenses, use revolving credit, or simply sell the property. Although some government entities offer programs for qualified individuals, such as senior property owners, to defer the payment of rising property taxes to avoid foreclosure or forced private sale of the property, these programs are limited to a qualifying few, do not benefit most consumers, and require annual application for the requested deferral. Further, such government programs are often indefinite deferrals that leave the government entity and the property owner at risk of home equity being insufficient collateral for the deferral.

Accordingly, there is a need for an improved financing method to assist property owners with the payment of increasing additional expenses, such as property taxes and insurance, associated with the property.

### SUMMARY OF THE INVENTION

The present invention answers this need by providing a method for financing increases above a predetermined expense amount associated with a property with a loan to pay the increases. In an embodiment of the invention, the loan is secured by the property associated with the increase.

In an embodiment of the invention, an expenses increase loan may be provided directly by a lender to a borrower. In other embodiments, a broker may assist a borrower in establishing a loan with a lender.

In embodiments of the invention where a broker assists the borrower, a broker communicates an initial expense amount associated with a property to a borrower, brokers a loan for a lender to pay increases above the initial expense amount and communicates the loan terms to the borrower.

In some embodiments, the loan is originated with a typical principal and interest mortgage loan at initial purchase or refinancing. In other embodiments, an expense increase loan is established when a borrower seeks assistance in paying property expense increases, independent of a pre-existing mortgage.

In one embodiment of the invention, a loan secured by the property is originated to cover increases in property taxes, insurance premiums and/or similar expenses that rise with the property value. In further embodiments, the increase loan is provided with a predetermined time for repayment.

In an embodiment of the invention, a predetermined expected initial expenses amount associated with a property, such as property taxes, insurance and the like, provides an expenses baseline amount. An expenses increase loan of the invention includes an agreement for the lender to pay the annual increases above the initial expenses determination. The loan includes an agreement for the borrower to repay the loan within a predetermined repayment period.

In embodiments of the invention, a lender automatically pays the increases directly to the collecting party and adds the payment amounts to the loan balance. In other embodiments, the borrower or property owner presents an increase amount for payment by the lender or receives reimbursement for self-payment of the property expense increase.

In some embodiments where a loan includes a predetermined time at which the loan is due, a borrower may pay the loan balance before or on the due date by direct payment, through refinance or at time of sale of the property. It will be appreciated that payment during refinance or at time of sale of the property liquidates the equity in the property for payment of the loan balance.

### BRIEF DESCRIPTION OF THE DRAWINGS

FIG. 1 is a flow diagram depicting a method for financing an incremental expense increases associated with property in an embodiment of the present invention.

### DETAILED DESCRIPTION OF THE INVENTION

The present invention provides a method and loan to pay increases in property taxes, insurance premiums and/or other property-value dependent expenses. In embodiments of the invention, the borrower pays or continues to pay the initial expenses determined at purchase or refinance of a property, such as by escrow or direct payments, while a lender pays the increase in expenses that rise with the value of the property, i.e., the difference between a current “higher” expense and the initial “baseline” expense. The lender's payments to cover the increase(s) is added to the loan and secured by the borrower's equity in the property. It will be appreciated that the increase in value of the property provides an increase in equity as security for the incremental increase loan. The lender typically charges interest, and the loan is typically paid at time of sale or refinance of the property. In some embodiments, a borrower may also elect to pay the loan independent of a sale or refinance directly.

It will also be appreciated that the loan of the present invention provides a agreement between a lender to pay the property expense increases and the borrower to repay the loan. In embodiments of the invention, the borrower also agrees that the loan will be repaid within a predetermined time period. By establishing a time period, the lender can estimate the rising equity and determine the sufficiency of such equity as collateral against the lender's projected property increase expense payments.

It will be appreciated that loans of the present invention may be established directly between a lender and borrower or through a broker. Loans of the present invention, like traditional mortgage loans, may also be transferred from a loan originator to a lender.

In embodiments of the invention, the loan and method described is used for financing property expense increases associated with residential properties, such as single-family primary homes, secondary homes, investment residential properties, multiple unit residential properties, and the like. In some embodiments, the present invention may also be used in conjunction with commercial properties.

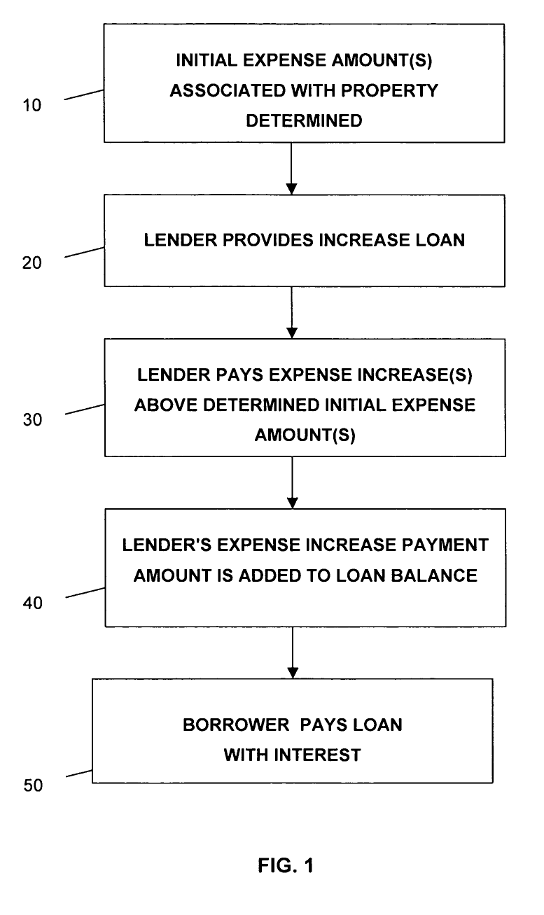

Referring to FIG. 1, a method of one embodiment of the present invention is shown.

At step 10, a lender, broker or other loan originator determines the initial expenses, such as property taxes and insurance premiums, that are to be paid in connection with a property. This determination is typically made at the time of a new purchase of the property or a refinance. Typically a monthly escrow payment is made by the mortgagor to cover these expenses; however, in some embodiments a property owner/borrower may pay such expenses directly to a government taxing agency or an insurer.

In embodiments including a broker, the broker can communicate these initial expenses, such as taxes and insurance, that the borrower is expected to pay in addition to the mortgage payments.

At step 20, and with the borrower's acceptance, a loan is provided that includes a lender's agreement to pay expense increases above the initial expenses (such as above initial amounts being paid into escrow) on the borrower's behalf. The loan includes the borrower's agreement to repay the expense increases paid by the lender. In one embodiment, the property expense increase loan is secured by the property. In other embodiments, the loan may be secured by other collateral. The loan typically carries an interest rate and has a predetermined time for repayment. In some embodiments, the loan may also include an application and/or origination fee, presenting a further income opportunity for brokers and lenders.

In some embodiments of the invention, a simple qualification application is provided at step 20 which is not credit score driven. Because payment of the incremental increase in expenses is secured by the property, a simple credit check, a title search, existing loans review, and review of current expenses (e.g. property tax bills and insurance premiums) is made to confirm that there is, and that there will continue to be with rising property value, sufficient equity to secure the loan for payment of the incremental expense increases. It will be appreciated that a direct lender or broker may carry out the qualification.

Although embodiments of the invention are associated with the increase loan being offered in conjunction with a new mortgage or refinance loan, it will be appreciated that other embodiments of the invention include an expenses increase loan being originated to borrowers with no mortgage (or a separate pre-existing mortgage). In such embodiments, a simple qualification procedure is used to confirm sufficient equity, and rising equity, to secure the expenses increase loan. In other embodiments it will be appreciated that the offering of an expenses increase loan to borrowers without a mortgage or with a pre-existing mortgage, provides a marketing opportunity for the lender to offer financial products to the potential customer, such as a home equity loan, possible refinance, and the like.

In embodiments of the invention including a loan to cover increases in insurance premiums, the financing method may include procedures to differentiate or exclude insurance increases due to increased behavioral and environmental risks that are independent of increased property values. The lender may choose to finance only that portion of the increase in property insurance which is directly related to the increased value of the property (rather than increases caused by other risk factors).

In some embodiments of the invention which include a loan to cover increases in property taxes, the financing method may include procedures to differentiate or exclude property tax increases due to increases in the property tax rates imposed by taxing authorities that are independent of increased property values. The lender may choose to finance only that portion of the increase in property taxes which is directly related to the increased value of the property (rather than increases caused by increased rates of taxation.)

At step 30, an expense increase, such as an incremental increase in property taxes above the taxes initially determined and being paid by the borrower (e.g. escrow or direct payment), is presented to and paid by the lender. The increase amount may be provided directly from the party seeking payment of the expense to the lender, such as part of a higher annual property tax bill provided by a government taxing agency to the lender. The increase amount may also be presented by the borrower to the lender, such as by forwarding a bill reflecting the tax increase or presenting a reimbursement request with a copy of the expense bill.

At step 40, the lender adds the payment of the expense increase to the loan balance.

At step 50, and preferably on or in advance of the loan payment due date, the loan is paid on behalf of the property owner/borrower, including applicable interest. In embodiments of the invention, the loan is paid at the time of sale of the property or a refinance of the property, as the owner liquidates equity in the property.

The following scenarios provide examples of how the invention may be applied; however, it will be appreciated that such examples are only illustrative and other embodiments of the invention fall within the scope of the claims:

Scenario 1: No existing mortgage on the property.

An owner has purchased the property a long time ago, and the owner has clear title. The owner faces an increase in property taxes and desires a loan as described.

A simplified qualification method is used, such as including proof of title with no liens and a copy of the current tax bill to establish a base line from which financing will be arranged.

The borrower enters into a financing agreement in which the lender will pay annual/regular increases in the property taxes, and/or insurance premiums for that property over the term of the agreement.

It will be appreciated that this financing scenario is distinguished from other earlier programs aimed at tax deferral or insurance deferral methods for low income and ‘special economic’ groups. In those earlier programs, the total amount of the tax/insurance bill would be “deferred”, not “paid,” under the deferral program and have no repayment period. These conventional deferral programs also present increased risk for the government deferrer because typically the government defers the total amounts of insurance/taxes, not annual increase amounts secured by the property equity, regardless of whether the property value has increased. In the present invention, the lender advances money when the underlying property value increases to secure the expense increase loan. Often, the property tax rate is based on current market value. Assuming an estimated tax rate of about 1.25% to about 2% per year, the annual expenses increase is only a small proportion of the assessed market value of the property, thereby affording the lender a considerable equity increase (margin) to secure the loan in the present invention.

Scenario 2: Borrower is interested in either financing a new property acquisition, or in refinancing an existing mortgage/financing arrangement.

Two situations in embodiments of the invention include: (1) where the mortgage is arranged without an escrow account, the borrower is required to pay the tax plus insurance bills and the borrower must promptly provide proof of payment to the lender; or (2) where the mortgage includes an escrow account, the borrower is required to advance payments to the lender sufficient to cover the estimated tax and insurance bills for the property. The lender will then withdraw funds from the escrow account to make the tax and insurance payments on behalf of the borrower.

Where there is no escrow requirement, the invention provides financing to the borrower similar to Scenario 1, except that the lender takes a second mortgage/charge on the property (unless the lender is the existing first mortgagee).

In certain embodiments, the invention is used in situations that do not necessarily involve an existing first mortgage or other first charge secured on the real estate. The invention can be used in cases where there may be an existing second mortgage, liens and other earlier charges. In that case, the financing offered under the invention would be secured by something other than a second mortgage or other second charge.

In other cases, an existing first mortgagee provides financing under the invention. The financing for property tax/insurance premium increases does not have to come from a third party lender. The initiating lender can offer the method of financing to supplement existing long term mortgages that are not due for renewal for several years.

In other embodiments, the invention is used to finance property tax and insurance premium increased escrow payments arising under an existing mortgage with escrow payment requirements. Two exemplary ways in which the increased cashflow requirements arise because the borrower will have to pay more into the escrow account include: (1) an increased monthly payment or increased payments into the escrow account (typically based on the lender's estimates of the increased funding needs), and (2) increases in the actual property tax bill and/or insurance premiums for a particular year. The borrower can obtain financing based on the increases resulting from the escrow demands (as seen on notices from the existing lender in which the lender usually estimates the increased amounts), or based on the total amount of the increase calculated directly from the new property tax bill and/or insurance premium notice. The lender can secure the loan in the same way. However, the financing arrangement may be based on increases to either the escrow funding or the actual tax/insurance bills.

In some cases, the borrower may not be alerted to the impending increases in tax bills or insurance premiums imposed by a taxing authority or an insurer because the taxing authority/insurer may send the notice directly to the lender, the notices of increase may be lost or misdirected or the lender may not give sufficient advance notice of the upcoming increases for payments into the escrow account. If the lender subsequently imposes an escrow requirement, or the lender requires the borrower to increase payments into an escrow fund, the invention can be used to provide financing for incremental increases arising because of increased property values.

Scenario 3: Borrower has an existing mortgage (or other financing arrangement) and the borrower wishes to finance increased real estate taxes and/or insurance premiums while maintaining the mortgage arrangement.

In this embodiment, the borrower is not necessarily seeking re-financing, but he/she wishes to finance increases in property tax/insurance costs over the remaining term of the existing mortgage, over some other term or independent of the term of the existing mortgage.

This situation is similar to Scenario 2. In this case, the borrower approaches a lender other than the entity who initiated the initial mortgage or a refinance mortgage loan. In another case, the borrower approaches the current mortgagee, or the initiating mortgagee, and asks for financing for increases to the tax/insurance bills.

In some embodiments, the invention is used to finance delinquent tax bills and situations involving lapsed insurance coverage (or borrower's failure to promptly notify the lender of existing insurance coverage). In the case of a delinquent tax bill, the amount of the loan for the first year will be the amount of the unpaid tax bill, insurance premium, and/or mortgage payments. The borrower seeks financing for that unpaid amount (as a one time advance), plus financing to protect against future increases in taxes and insurance premiums. This situation is a variation of the first 3 scenarios in which it is typical that the borrowers are good credit risks (for “A” type loans). In this situation, the lender may be looking to advance money to B or C type loan candidates with corresponding higher credit risks.

Accordingly, the present invention provides many advantages to both borrowers and lenders.

For borrowers/owners cash flow is stabilized and predictable from year to year. Further, in some embodiments an alternative financing option is provided for overcoming delinquencies without refinancing of existing beneficial mortgages or loans. Further, if a delinquent borrower can avoid refinancing of the underlying loan, the borrower can maintain what is often a much better loan rate than if she/he must seek refinancing (where their higher risk will be assessed) to overcome delinquencies in paying mortgage payments, insurance and tax bills. In other embodiments of the invention, it will be appreciated that financing under the invention can be used to target a one-time delinquency plus future increases in tax and insurance bills, or any combination of these three components.

For the lender, the invention provides an opportunity to offer financing strategies to existing and new customers, earns interest on the loan paying expenses increases and earns application fees for originating the loan. Another advantage to the lender is that in many embodiments of the invention, a loan program can be established as a ‘choice’ loan, outside of the existing regulatory frameworks, thus allowing the lender greater flexibility in terms of how the lender may wish to implement its ‘choice’ loan programs.

In further embodiments of the invention, a potential new lender can offer financing for increased taxes/premiums or increased escrow funding, although the borrower obtained a first mortgage or loan from another lender. During borrower qualification, the potential new lender has an opportunity to analyze the borrower's credit situation and the potential new lender can decide whether to offer a loan to finance those property tax and insurance increases. In addition, the potential new lender is provided an opportunity to offer a loan program to refinance the existing mortgage or offer other financial products that may be beneficial to the potential borrower.

It will be understood that the present invention may be utilized in various embodiments by loan originators, lenders, and companies which administer and collect loan payments. Loan originators include, for example, lending companies (for example banks, credit unions and other financial institutions), mortgage brokers and entities acting as co-brokers for loan arrangements. In some embodiments, a single loan may be originated by a first broker, who may in turn refer the potential borrower to a co-broker in return for a referral fee.

In some embodiments, a co-broker includes a lender that refers a customer seeking an expense loan of the present invention, but the customer does not qualify under the lender's standards. The lender may refer or sell the business to another lender with lower qualification standards for the loan, and earn a percentage of the referred loan as a referral fee.

In further embodiments, the broker (or co-broker) will investigate available loan programs and will obtain quotations for a loan commitment from a lender. The broker will negotiate the loan arrangements with the potential lender. The lender will adopt those arrangements with the borrower and will advance the funds to the borrower. The lender may subsequently assign or transfer the loan commitment to another entity who will subsequently administer the loan and collect payments under the loan commitment.

As described, the difference between a current “higher” expense and initial expense directly relates to an increase in the value of the associated property in embodiments of the invention. In one embodiment, a property value-expense index is established by a loan originator based on the estimated initial expense(s) and property value.

The property value-expense index is determined according to the pre-established lending criteria for that financing arrangement. In embodiments of the invention, a loan originator adopts predetermined lending criteria to enhance the loan originator's ability to later assign or transfer the loan obligation to a collection agency or financial institution. In further embodiments, a loan originator chooses which initial expense amounts will be included in the property value-expense index covered by the financing arrangement. The financing arrangement is indexed with regard to an initial value of the property and one or more of the following initial expense amounts: (i) initial property tax expense; (ii) initial property insurance expense; and (iii) an initial other property related expense.

Similarly, the determination of the initial value of the property is selected with regard to one or more property valuation methods used by government taxing authorities, property insurers, appraisers, sales figures and other property value estimators. In general, increases in the property value-expense index will correspond to increases in one or more of the initial property expenses.

A property value-expense index is used in embodiments of the invention by prospective loan originators to assess property related trends within certain communities, neighborhoods, cities and other areas. These loan originators may use the index to identify the market potential for offering methods of the invention within those areas.

For example, in one embodiment, a property increase value trend index, or PIVF index, provides a barometer to reflect the financial health and risk factors associated with an increase expense loan of the invention. A potential lender can assign an index value, such as on a scale of 1 to 5, to predetermined geographic areas in which property is present, that reflects the strength of increasing property values within the geographic area. It will be appreciated that such index may also include other factors such as current and projected tax rates, property risks, new developments, and other variables that a lender determines to bear on the risk of the loan. An index value of 1 represents the most desirable loan to the lender and an index value of 5 reflects the least desirable. When a customer seeks an increase loan of the invention, the index value for the property's location provides many tools for the lender. The lender can establish an interest rate based on the index value (i.e. 1 to 5) added to a pre-determined rate (such as fixed percentage). For example, a desirable loan for a property in an area with index value of 1 will have a lower interest rate increase loan, while an index value of 5 will result in a much higher rate for the increase loan. In other embodiments, particular financial products may be offered to customers with properties having a lower index value, the qualification procedure may be simpler for loans covering properties with lower index values, and/or particular loan amount limits may be established depending on the index value. In each case it will be appreciated that different lenders may have different criteria for establishing the PIVR index and may use the index value for different purposes. In this regard, it will be further appreciated that various numerical scales may be employed, and a scale of 1 to 5 is merely illustrative.

Accordingly, while the invention has been described with reference to the methods and examples disclosed, it is not confined to the details set forth, but is intended to cover such modifications and changes as may fall within the scope of the following claims.

What is claimed is:

1. A method for financing payment of a property expense increase comprising providing a loan secured by a property to pay an increase portion amount above a predetermined initial expense amount associated with the property and establishing a predetermined term for a borrower's repayment of the loan.

2. The method of claim 1 wherein the initial expense amount includes estimated property taxes.

3. The method of claim 1 wherein the initial expense amount includes estimated insurance premiums.

4. The method of claim 1 wherein the incremental expense increase includes an increase in property taxes.

5. The method of claim 1 wherein the incremental expense increase includes an increase in insurance premiums.

6. The method of claim 4 further comprising adding a plurality of annual tax increase payments against a plurality of annual tax increases to a balance amount of the loan.

7. The method of claim 6 further comprising establishing a loan term identifying a date for repayment of the loan.

8. A method for financing property expense amount increases comprising:
communicating to a borrower an initial expense amount associated with a property, wherein the initial expense amount includes at least one amount selected from the group consisting of estimated annual property taxes and estimated annual insurance premiums;
brokering a loan for a lender to pay one or more annual expense increases above the initial expense amount on behalf of the borrower; and
communicating terms of the loan including a predetermined loan repayment time period to the borrower.

9. The method of claim 8, wherein the loan is secured by the property.

10. The method of claim 8, further comprising receiving a referral payment from a member of a group consisting of a lender and a broker.

11. A property expense increase loan comprising:
an agreement for a lender to pay an increase above a predetermined expense amount associated with a property; and
an agreement for a borrower to repay the loan within a predetermined time period.

12. The property expense increase loan of claim 11, wherein the increase is selected from the group consisting of a property tax increase amount and insurance premiums increase amount.

13. The property expense increase loan of claim 12, wherein the loan is secured by the property.

14. The property expense increase loan of claim 13, further comprising an agreement for the lender to pay a plurality of annual increases within the predetermined time period.

15. A method for financing payment of property expense increases comprising:
receiving a request for payments of annual property expense increases exceeding an initial property expense amount; and
providing a loan with a predetermined term for repayment of the payments of annual property expense increases.

16. The method of claim 15, wherein the property expense increases include property tax increases.

17. The method of claim 16 wherein the property expense increases include insurance premiums increases.

18. The method of claim 17 further comprising brokering the loan between a lender and borrower.

19. The method of claim 16 further comprising brokering the loan between a lender and borrower.

20. The method of claim 15 further comprising brokering the loan between a lender and borrower.

21. The method of claim 16, further comprising simultaneously providing a mortgage loan including principal and interest payment terms associated with the property.

22. A method for financing payment of a property expense increase comprising establishing a property increase value trend index applicable to a property and providing a loan based on the index to pay an increase portion amount above a predetermined initial expense amount associated with the property.
